(19) United States
(12) Patent Application Publication
(10) Pub. No.: US 2004/0154625 A1
(43) Pub. Date: Aug. 12, 2004

(54) MOUTHGUARD AND METHOD OF MAKING THE MOUTHGUARD

(76) Inventor: Timothy W. Foley, Birmingham, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/749,891

(22) Filed: Dec. 31, 2003

Related U.S. Application Data
(60) Provisional application No. 60/437,379, filed on Dec. 31, 2002.

(51) Int. Cl. A61C 5/14

(52) U.S. Cl. 128/859

(57) ABSTRACT

A mouthguard to protect an arch of a user includes an outer wall covering a buccal surface of teeth. The outer wall includes a force absorbing inner layer, a force absorbing outer layer and a force transmitting layer positioned therebetween the force absorbing inner layer and the force absorbing outer layer. An inner wall is positioned opposite the outer wall to cover a palatal surface of the teeth, and includes the force absorbing inner layer and the force absorbing outer layer. A lower wall is disposed between the outer wall and the inner wall to cover an occlusal surface of the teeth. The lower wall includes the force absorbing inner layer and the force absorbing outer layer. The outer wall, inner wall and lower wall form a U-shaped channel that is molded into the shape of the arch. The method of making the mouthguard includes the steps of casting a model of a user's arch, molding a force absorbing inner layer of material to the model to form a force absorbing inner layer of the mouthguard. The method also includes the steps of molding a force-transmitting layer of material over the force absorbing inner layer in a predetermined position, and molding a force absorbing outer layer of material over the force absorbing inner layer and force transmitting layer. The method further includes the steps of finishing the mouthguard to conform to the arch of the user.

### RELATED APPLICATIONS

This application claims priority of U.S. Provisional Patent Application No. 60/437,379 filed Dec. 31, 2002 and is incorporated herein by reference.

### BACKGROUND OF THE INVENTION

1. Field of the Invention

The present invention relates generally to oral appliances and, more specifically, to a mouthguard and a method of making the same.

2. Description of the Related Art

Oral appliances are utilized for many purposes, including orthodontic treatment, prosthetics and injury prevention. One type of oral appliance widely used for injury prevention is a mouthguard. The use of a mouthguard is known to potentially reduce the risk and/or severity of orafacial and cerebral injuries, such as those resulting from an impact to the head. Many contact sports, including football, hockey, basketball, baseball or the like, require the use of a mouthguard, due to the inherent risk of injury associated with the sport.

Although mouthguards are proven effective in preventing or reducing injury, the athletes themself do not like to wear the device, since presently available mouthguards are uncomfortable to wear, and hinder functions, such as breathing or talking. Various styles of mouthguards are known in the art. One style of mouthguard is a one-piece design with an upper channel for the upper arch and a lower channel for the lower arch. With this style, the user clenches their teeth together to retain the mouthguard in place. Another style of mouthguard is a two-piece design with an upper channel for the upper arch connected to a lower channel for the lower arch. This style is also difficult to retain in place, as well as to remove. Still another style of mouthguard is a single channel design that fits over the upper arch. While this style is more comfortable to use, it is generally not as protective as the aforementioned styles.

The various styles of mouthguards are generally sized and molded using one of the following methods. A universally sized mouthguard is designed and molded to fit a wide range of users. A semi-custom mouthguard is designed to fit a wide range of users, but is form fit by the user using a heat, bite and cool technique. A custom fit mouthguard is molded from an exact impression of the user's mouth. Although a custom fitted mouthguard is more comfortable to wear, it is still relatively cumbersome to use, and requires clenching of the teeth in order to retain in place, which interferes with breathing or talking while in place. Thus, there is a need in the art for a mouthguard that protects the user, with minimum discomfort or inconvenience to the user.

### SUMMARY OF THE INVENTION

Accordingly, the present invention is a mouthguard and a method of making a mouthguard. The mouthguard includes an outer wall covering a buccal surface of the teeth. The outer wall includes a force absorbing inner layer, a force absorbing outer layer and a force transmitting layer positioned therebetween the force absorbing inner layer and the force absorbing outer layer. An inner wall is positioned opposite the outer wall to cover a palatal surface of the teeth, and includes the force absorbing inner layer and the force absorbing outer layer. A lower wall is disposed between the outer wall and the inner wall to cover an occlusal surface of the teeth. The lower wall includes the force absorbing inner layer and the force absorbing outer layer. The outer wall, inner wall and lower wall form a U-shaped channel that is molded into the shape of the arch. The method includes the steps of casting a model of a user's arch, molding a force absorbing inner layer of material to the model to form a force absorbing inner layer of the mouthguard. The method also includes the steps of molding a force-transmitting layer of material over the force absorbing inner layer in a predetermined position, and molding a force absorbing outer layer of material over the force absorbing inner layer and force transmitting layer. The method further includes the steps of finishing the mouthguard to conform to the arch of the user.

One advantage of the present invention is that a mouthguard is provided that is molded to independently fit either one or both of the arches of the user. Another advantage of the present invention is that the mouthguard is a composite structure, with a preformed, longitudinally extending, force-transmitting layer embedded between an inner force absorbing layer and an outer force absorbing layer. Another advantage of the present invention is that the mouthguard does not obstruct the user's breathing or interfere with the user talking or drinking. Still another advantage of the present invention is that the force-transmitting layer is a reinforcing material made from a plurality of fibers embedded in a resinous material approved for dental usage. Yet still another advantage of the present invention is that the inner and outer layer is of a predetermined thickness to attenuate impact forces. A further advantage of the present invention is that the mouthguard can be semi-custom molded. Still a further advantage of the present invention is that a mouthguard sizing apparatus is provided for correctly sizing a universally fit mouthguard. Still yet a further advantage of the present invention is that the mouthguard can be attached to a helmet or the like, and the attachment point may further attenuate an impact force. A further advantage of the present invention is that a method of making the mouthguard is provided.

Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is a perspective view of a mouthguard positioned on an upper arch, according to the present invention.

FIG. 2 is a side sectional view of the mouthguard and a tooth of FIG. 1, according to the present invention.

FIG. 3 is a top view of the mouthguard of FIG. 1, according to the present invention.

FIG. 4 is a flowchart of a method of making the mouthguard of FIG. 1, according to the present invention.

FIG. 5 is a side view of an alternative embodiment of the mouthguard with a gas-liberating additive in the force absorbing layer, according to the present invention.

FIG. 6 is a perspective view of the force transmitting layer having a predetermined shape, according to the present invention.

FIG. 7 is an elevational view of a sizing device for use with the mouthguard of FIG. 1.

FIG. 8 is a side view of a helmet with the mouthguard attached and an energy absorbing mechanism, according to the present invention.

FIG. 9 is a side view of a helmet with another embodiment of a tapered recess energy absorbing mechanism, according to the present invention.

FIG. 10 is a side view of a helmet with a further embodiment of a grommet energy absorbing mechanism, according to the present invention.

### DESCRIPTION OF THE PREFERRED EMBODIMENT(S)

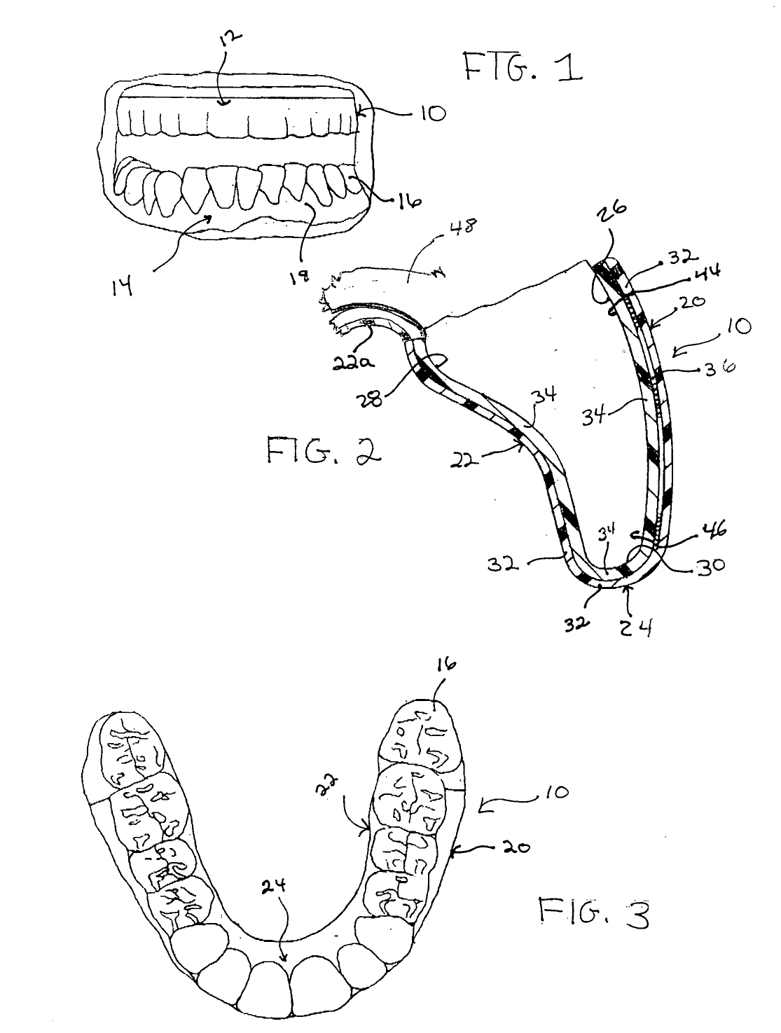

Referring to FIGS. 1-6, a mouthguard 10 according to the present invention is provided. It should be appreciated that the mouthguard is worn over either one of the upper arch 12 or the lower arch 14, or both arches, depending on the desired protection by the user. The arches 12, 14 include the teeth 16, soft tissue and muscle attachments 18. In this example, a mouthguard 10 positioned over the upper arch 12 is illustrated.

The mouthguard 10 is a u-shaped member, having an outer wall 20, an inner wall 22 opposite the outer wall 20, and a lower wall 24 disposed therebetween to form an integral channel for receiving the teeth 16 and soft tissue 18. It should be appreciated that the outer wall 20 is generally configured to conform to the buccal surface 26 of the tooth 16, the inner wall 22 is generally configured to conform to the palatal surface 28 of the tooth 16, and the lower wall 24 is generally configured to conform to the occlusal surface 30 of the tooth 16.

In an alternative embodiment shown in FIG. 2, the mouthguard 10 will also have a portion for covering a soft palate portion 48 of the user's mouth. In certain types of activities utilizing a stick, there is an opportunity for injury to the mouth due to the stick in the mouth. It is also contemplated that the user will only use an upper mouthpiece. The mouthpiece 10 includes a palate protective wall 22a extending radially from an end of the inner wall 22. The contour of the palate protective wall 22a conforms to the shape of the soft palate 48 of the user.

The mouthguard 10 is formed as a composite layered structure. The outer wall 20 includes a force absorbing outer layer 32, a force absorbing inner layer 34 and a force-transmitting layer 36 imbedded between the outer layer and the inner layer in a predetermined position. It should be appreciated that both the inner wall 22 and lower wall 24 include a force absorbing outer layer 32 and a force absorbing inner layer 34.

The force absorbing outer and inner layers 32, 34 are composed of a material selected from a class of materials approved by the FDA for dental use that are capable of absorbing a force and have resilient, moldable and settable properties. One example of such a material is a thermoplastic.

The force absorbing requirements of the material is dependent on the anticipated impact force. Various impact forces are contemplated, such as that of a hockey puck from a slap shot, or the like. It is contemplated that the anticipated impact forces may be determined by techniques including actual testing, or a mathematical simulation, or combination of such techniques. It is also contemplated that the thickness of the force absorbing outer and inner layers 32, 34 is selected to adequately absorb the anticipated impact force. For certain uses of the mouthguard 10, the entire structure may be less than 1/16″ thick.

It should be appreciated that the material for the force absorbing inner layer 34 and force absorbing outer layer 32 may be preformed into a predetermined shape for ease of use prior to molding, such as a planar sheet or the like. An example of a preformed thermoplastic material for dental purposes is the Sof-Tray-Sheet manufactured by Ultradent.

For certain types of mouthguards 10, such as a semi-custom mouthguard, it is contemplated that the material for the force absorbing inner layer 34 or force absorbing outer layer 32 may include a chemical additive having a predetermined property. For example, the additive may have a chemical property that would allow the mouthguard material to be relatively rigid below a first predetermined temperature, such as ambient temperature, and moldable at a second predetermined temperature that is significantly higher than the first predetermined temperature. This attribute would allow the mouthguard 10 to be semi-custom molded by the user.

Another example of an additive is a colorant. The colorant is mixed into the raw material, so that the end product has a desired color, such as black or white.

In an alternative embodiment, the material for the force absorbing inner layer 34 includes a gas-liberating additive, as shown in FIG. 5 at 42. It is contemplated that the gas-liberating additive may also be added to the material for the force absorbing outer layer 32. The gas-liberating additive may be already present in the force absorbing inner layer material prior to molding, or added to the force absorbing inner layer material during the molding process. An example of gas-liberating material is a chemical foaming agent that is chemically reactive upon the application of heat, resulting in the liberation of air bubbles 42 that become trapped in the melting material, due to the lower density of the air bubbles 42 than that of the melting material. This process is referred to in the art as foaming. As the material is cooled, the air bubbles 42 remain suspended in the material, thereby reducing the density and amount of material. It should be appreciated that the presence of air bubbles 42 in the material improves the force absorbing characteristics of the material without additional bulk. Various types of chemical foaming agents are known in the art and safe for use in dental applications, such as baking soda, a carbonate, or the like.

The force transmitting layer 36 is a composite dental material selected from a class of materials that is suitable for dental use and have settable, and force transmitting properties. An example of the force transmitting layer 36 is shown in FIG. 6, and includes a plurality of long fibers 38 embedded in a resin matrix 40. It is contemplated that the fibers 38 are a force transmitting material, such as glass, carbon, or quartz or the like. Similarly, the fiber 38 may be a composition of glass and carbon fibers or other such similar materials. The resin matrix 40 binds the fibers 38 together. Various resins approved for use in dental applications are contemplated, such as a synthetic resin, a dental monomer polymer resin, a light or self cure composite resin, an epoxy resin, a polyester resin, an acrylic resin, or the like. It should be appreciated that the fibers 38 may be woven together into the resin matrix 40 and provided as a ribbon of material for ease of handling.

The force transmitting layer material may include an additive. For example, the force transmitting layer material may include an additive to enhance its setting characteristics. Preferably, over 60% of the volume of the force transmitting layer material is composed of the fibers 38. In this example, the fibers 38 are equally tensioned and have a unidirectional longitudinal arrangement. The fibers 38 advantageously distribute a shear force along their length.

In an alternative embodiment, the force transmitting layer material may include short fibers 38 strategically placed relative to the long fibers 38 to enhance the force transmitting characteristics of the material.

The force transmitting layer material may be preformed in a predetermined shape for ease of handling in molding the mouthguard 10. For example, the force transmitting layer material is woven together and provided as a strip or ribbon. The strip may be commercially available on a roll, or in a preformed shape, as will be described.

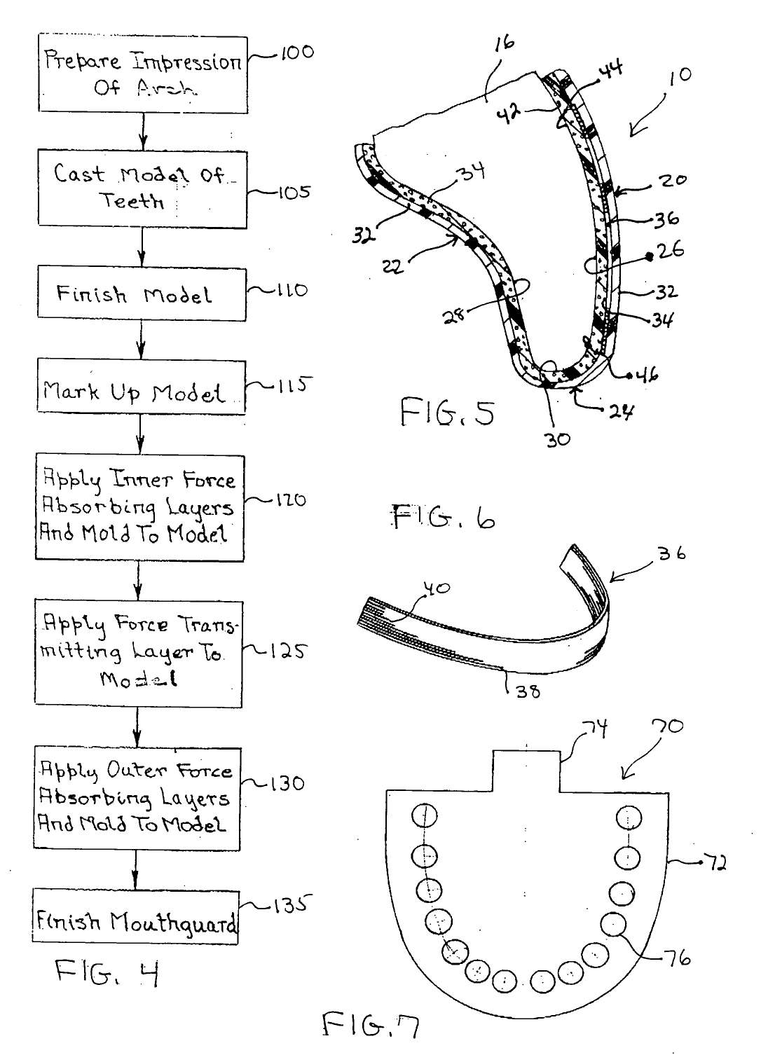

Referring to FIG. 4, a method of forming a mouthguard 10, as described with respect to FIGS. 1-6, is illustrated. The methodology begins in block 100 with a dental professional preparing an impression of a user's arch 12, 14. It is contemplated that the user is a specific indivual desirous of a custom mouthguard, or representative of a group of individuals with a similarly sized arch 12, 14 desirous of a semi-custom mouthguard, or representative of a typical individual for a universal mouthguard. Various methods of making an impression are known in the dental art. Preferably, the impression captures the shape and form of the user's teeth 16 and includes soft tissue and muscle attachments 18.

The methodology advances to block 105, and the dental professional casts a model of the user's teeth using a negative casting technique, as is known in the dental art. The model is cast in a known dental material, such as Dental stone, or the like.

The methodology advances to block 110 and the model is finished to accurately reflect the configuration of the arch 12, 14, including teeth 16, soft tissue and muscle attachments 18.

The methodology advances to block 115 and the model is marked to indicate how much of the arch 12, 14 is to be covered by the finished mouthguard. Preferably, the finished mouthguard covers the teeth 16 and a predetermined amount of soft tissue 18 extending beyond the teeth, while remaining free of any muscle attachments.

The methodology advances to block 120 and the force absorbing inner layer material is applied and molded to the model to form the force absorbing inner layer 34. Various techniques are available in the art to mold the force absorbing inner layer material to the model, including heat vacuum forming. In this example, the force absorbing inner layer material is a thermoplastic, as previously described. Preferably, the force absorbing inner layer 34 has a predetermined thickness, which in this example is between 1-1.5 mm thick.

It should be appreciated that force absorbing inner layer material may include a light curable composite additive to facilitate setting of the force absorbing inner layer 34. The material is preferably packaged in a sealed, light-blocking package, to avoid accidental curing of the material. This material is applied to the mold, trimmed to the desired shape, and light cured.

The methodology advances to block 125 and the force transmitting layer 36 is positioned on the model in a predetermined position over the force absorbing inner layer 34. Preferably, the force transmitting layer 36 is a strip of a force transmitting material, as previously described, of suitable thickness, length and width to protect the arch from an applied force. In this example, the force transmitting layer 36 is positioned over the outer wall 20 portion of the model, extending between a first molar tooth on one side of the arch and a first molar tooth on the other side arch, and from the incisal 44 to cervical 46 portion of the tooth 16.

It should be appreciated that the force transmitting layer material may be available on a roll, in which case a strip of suitable length is cut from the roll. The material may be available in various predetermined widths, in which case it may be trimmed to the appropriate size. It addition, the force transmitting layer material may be preformed into a u-shape, to facilitate handling, as shown in FIG. 6.

It should be appreciated that the force transmitting layer material may include a light curable composite additive to facilitate setting of the force transmitting layer 36. The force transmitting layer material is preferably packaged in a sealed, light-blocking package, to avoid accidental curing of the material. This material is applied to the mold and light cured.

The methodology advances to block 130 and the force absorbing outer layer 32 is applied over the combined force absorbing inner layer 34 and force transmitting layer 36 and is molded to conform to the shape of the model, using a known technique, as previously described. It should be appreciated that the force absorbing outer layer material may also include a light curable composite additive material to facilitate setting of the material. The force absorbing outer layer material is preferably packaged in a sealed, light-blocking package, to avoid accidental curing of the material. The force absorbing outer layer material is applied to the mold, trimmed to the desired shape, and light cured, as previously described.

The methodology advances to block 135 and the mouthguard 10 is finished. For example, excess material is trimmed from the mouthguard so that the mouthguard conforms to the shape marked on the mold. Also, edges may be deburred to remove sharp edges.

In use, the user places the mouthguard 10 for the upper arch 12 over the upper arch 12. The mouthguard 10 for the lower arch 14 is placed over the lower arch 14. The user may elect to wear both the upper and lower mouthguard, or just one, such as the upper mouthguard.

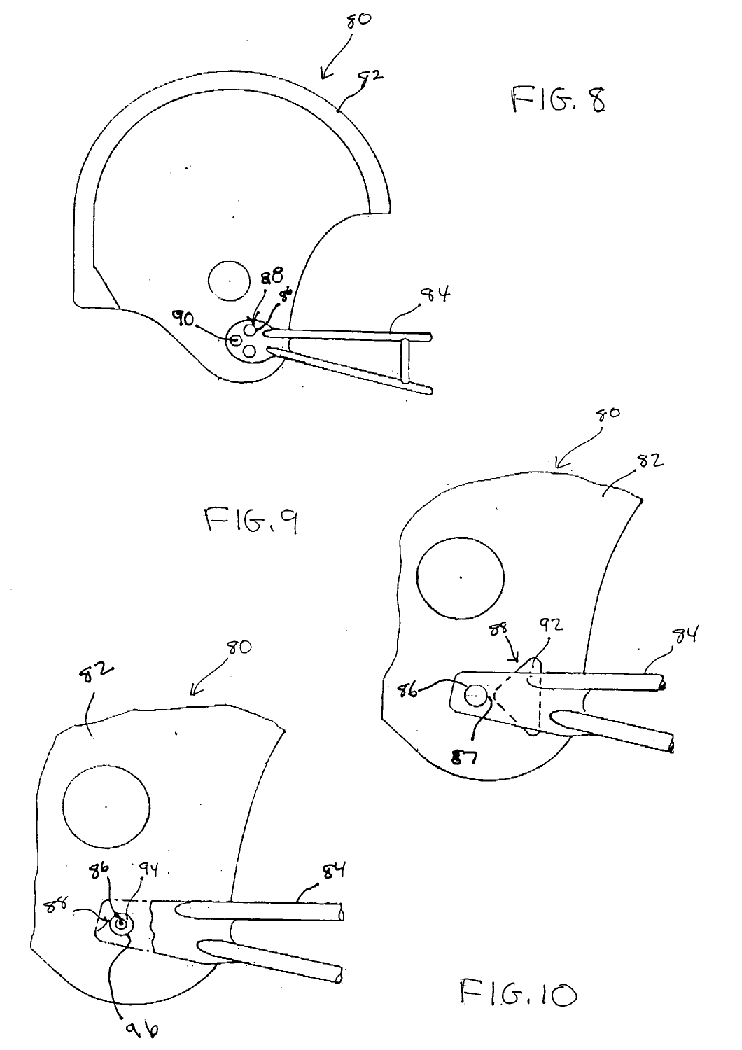

Referring to FIG. 7, a sizing device 70 for use in fitting a semi-custom mouthguard 10 is provided. In this example, the mouthguard 10 is a universal mouthguard 10 molded to fit a predetermined group of users, generally having a similarly shaped arch 12, 14. The sizing device 70 is used by the user to select an appropriately sized mouthguard 10, such as in a retail environment. Presumably, the mouthguard is manufactured in a predetermined range of sizes, such as from extra small to extra large, or the like.

The sizing device 70 includes a u-shaped bite member 72, resembling an arch. The sizing device 70 may include a handle 74 extending outwardly from an edge of the bite member 72. At least one arch shape 76, corresponding to the predetermined arch shapes for the available mouthguards 10, is defined on a face of the bite member 72.

The sizing device 70 is made of a semi-rigid material. For example, the material can be selected from the appropriate thermoplastic class of materials. Alternatively, the sizing device 70 is made of a semi-rigid edible material, such as gum. In use, the user inserts the bite member 72 portion of the sizing device 70 into their mouth and bites down into the bite member, thus creating an impression of their arch. The user compares the impression of their arch 12, 14 to the predetermined arch shapes 76 on the face of the bite member 72, and selects the appropriately sized arch. The user purchases a mouthguard 10 corresponding to the selected arch size.

In another embodiment of the present invention, the user is wearing head protection, such as a helmet 80 as shown in FIGS. 8-10. Helmets 80 typically include a rigid head protective portion 82 and a face guard 84. The mouthguard 10 may be attached the face guard 84 using an attaching means (not shown). An example of an attaching means is a strap, and one end of the strap is molded into the mouthguard outer wall, and the other end of the strap is configured to be secured to the face guard. The mouthguard 10 is attached using a known attaching means, such as a loop, or the like. While attaching the mouthguard to the helmet 80 works well in reducing the chance of facial or dental injury, it may increase the user's chance of a concussive injury. For example, a blow to the head in a predetermined location causes movement of the brain relative to the skull. By fixating the position of the skull via the mouthguard 10 and helmet 80, the chance of injury to the brain, such as a concussion, from the rebounding movement of the brain against the skull is decreased.

Previously, the face guard 84 was attached to the head protective portion 82 using a single point attachment. The attaching means is a rivet or screw or the like extending through an aperture in the helmet. In this embodiment, the faceguard is attached to the helmet 80 using an energy absorbing mechanism 88. In this example, the energy absorbing mechanism 90 is a plurality of attachment points 90 arranged in a predetermined pattern, as shown in FIG. 8. For example, the attachment points 90 are arranged in a triangular pattern. Advantageously, this pattern better distributes the applied forces in multiple directions to reduce the contact force between the brain and skull.

Alternatively, the energy absorbing mechanism 88 is a tapered recess 92 in the helmet, as shown in FIG. 9. The tapered recess 92 has a generally wedge shape, with a distal portion that is progressively narrower and thinner in cross-sectional area than a proximate portion of the recess. The tapered recess 92 is positioned near the attachment point 86 for the face guard 84 to the rigid head protective portion 82 of the helmet 80. A thin wall 87 separates the attachment point 86 for the faceguard 84 from the tapered recess 92. In use, the face guard attachment means 86 travels through the thin wall 87 and tapered recess 92 when a force is applied to the helmet 80. It should be appreciated that the positioning and dimensional characteristics of the tapered recess 92 may be selected so that the face guard 84 breaks away from the helmet 80 upon the application of a predetermined force.

Alternatively, the energy absorbing mechanism 88 is a grommet 94 disposed in an aperture 96 at the face guard attachment point 86, as shown in FIG. 10. The grommet 94 is made from an energy absorbing material, such as rubber.

It should be appreciated that the helmet 80 may include one or more mechanisms of the energy absorbing embodiments described herein, to optimize the energy absorbing capability of the faceguard and subsequent movement of the brain relative to the helmet 80.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A mouthguard to protect an arch of a user comprising:
an outer wall covering a buccal surface a tooth, wherein said outer wall includes a force absorbing inner layer, a force absorbing outer layer and a force transmitting layer positioned therebetween said force absorbing inner layer and said force absorbing outer layer;
an inner wall opposite said outer wall covering a palatal surface of the tooth, wherein said inner wall includes said force absorbing inner layer and said force absorbing outer layer; and
a lower wall disposed between said outer wall and said inner wall covering an occlusal surface of the tooth, and said outer wall, inner wall and lower wall form a U-shaped channel that is molded in the shape of the arch, wherein said lower wall includes said force absorbing inner layer and said force absorbing outer layer.

2. A mouthguard as set forth in claim 1 wherein said force transmitting layer includes of a plurality of longitudinally extending fibers disposed in a resinous matrix.

3. A mouthguard as set forth in claim 1 further comprising a palate protective wall extending radially from an edge of said inner wall, wherein said palate protective wall conforms to a shape of a palate of the user.

4. A mouthguard as set forth in claim 1 wherein said force absorbing inner layer and force absorbing outer layer are made from a class of materials approved for dental use having resilient, moldable, and settable properties.

5. A mouthguard as set forth in claim 4 wherein said force absorbing inner layer includes a chemical additive enabling the material to be rigid below a first predetermined temperature and moldable above a second predetermined temperature that is greater than the first predetermined temperature.

6. A mouthguard as set forth in claim 4 wherein said force absorbing inner layer material includes a gas-liberating chemical additive that is selected from a class of additives that is chemically reactive upon the application of heat to liberate air bubbles that become trapped in the force absorbing inner layer material.

7. A mouthguard as set forth in claim 1 wherein said force transmitting layer is made from a composite material selected from a class a materials approved for dental use having force transmitting properties.

8. A mouthguard as set forth in claim 7 wherein said composite force transmitting material includes a plurality of long fibers embedded in a resin matrix.

9. A mouthguard as set forth in clam 8 wherein said fibers are selected from a class of material that includes glass fibers, or carbon fibers or quartz fibers.

10. A mouthguard as set forth in claim 8 wherein said resin matrix is selected from a class of resinous materials including an epoxy resin, or a polyester resin or an acrylic resin.

11. A mouthguard as set forth in claim 7 wherein said force transmitting layer is formed as a strip.

12. A mouthguard as set forth in claim 11 wherein said strip is preformed.

13. A mouthguard to protect an arch of a user comprising:
an outer wall covering a buccal surface a tooth, wherein said outer wall includes a force absorbing inner layer and a force absorbing outer layer made from a class of materials approved for dental use having resilient, moldable, and settable properties, and a force transmitting layer positioned therebetween said force absorbing inner layer and said force absorbing outer layer made of a plurality of longitudinally extending fibers disposed in a resinous matrix;
an inner wall opposite said outer wall covering a palatal surface of the tooth, wherein said inner wall includes said force absorbing inner layer and said force absorbing outer layer; and
a lower wall disposed between said outer wall and said inner wall covering an occlusal surface of the tooth, and said outer wall, inner wall and lower wall form a U-shaped channel that is molded in the shape of the arch, wherein said lower wall includes said force absorbing inner layer and said force absorbing outer layer.

14. A mouthguard as set forth in claim 13 further comprising a palate protective wall extending radially from an edge of said inner wall, wherein said palate protective wall conforms to a shape of a palate of the user.

15. A mouthguard as set forth in claim 13 wherein said force absorbing inner layer includes a chemical additive enabling the material to be rigid below a first predetermined temperature and moldable above a second predetermined temperature that is greater than the first predetermined temperature.

16. A mouthguard as set forth in claim 13 wherein said force absorbing inner layer material includes a gas-liberating chemical additive that is selected from a class of additives that is chemically reactive upon the application of heat to liberate air bubbles that become trapped in the force absorbing inner layer material.

17. A mouthguard as set forth in clam 13 wherein said fibers are selected from a class of fiberous material includes glass fibers, or carbon fibers or quartz fibers.

18. A mouthguard as set forth in claim 13 wherein said resin matrix is selected from a class of resinous materials including an epoxy resin, or a polyester resin or an acrylic resin.

19. A mouthguard as set forth in claim 13 wherein said force transmitting layer is formed as a strip.

20. A mouthguard as set forth in claim 19 wherein said strip is preformed.

21. A method of making a mouthguard for a user, said method including the steps of:
casting a model of a user's arch;
molding a force absorbing inner layer of material to the model to form a force absorbing inner layer of the mouthguard;
molding a force-transmitting layer of material over the force absorbing inner layer in a predetermined position, wherein the force transmitting layer includes a plurality of longitudinally extending fibers disposed in a resinous matrix;
molding a force absorbing outer layer of material over the force absorbing inner layer and force transmitting layer to form a mouthguard having an inner wall covering a palatal surface of a tooth, an outer wall opposite inner wall covering a buccal surface of the tooth and a lower wall disposed therebetween the inner wall and outer wall covering an occlusal surface of the tooth; and
finishing the mouthguard to conform to the arch of the user.

22. A method as set forth in claim 21 further comprising the step of using a sizing device to determine the size of mouthguard to use, wherein said sizing device includes a u-shaped bite member having a handle extending from an edge, and a plurality of arch shapes indicated on a surface of the bite member corresponding to a mouthguard size.

23. A mouthguard as set forth in clam 21 wherein said fibers are selected from a class of fiberous material including glass fibers, or carbon fibers or quartz fibers.

24. A mouthguard as set forth in claim 21 wherein said resin matrix is selected from a class of resinous materials including an epoxy resin, or a polyester resin or an acrylic resin.
